(19) United States
(12) Patent Application Publication
(10) Pub. No.: US 2006/0049206 A1
(43) Pub. Date: Mar. 9, 2006

(54) POTABLE SANITARY WATER DISPENSING STATION

(76) Inventor: Ed Correia, Portsmouth, NH (US)

Correspondence Address: MESMER & DELEAULT, PLLC, 1 NEW HAMPSHIRE AVE., SUITE 125, PORTSMOUTH, NH, 03801, US

(21) Appl. No.: 11/161,909

(22) Filed: Aug. 22, 2005

Related U.S. Application Data
(60) Provisional application No. 60/522,150, filed on Aug. 21, 2004.

(51) Int. Cl. B67D 5/62

(52) U.S. Cl. 222/146.6

(57) ABSTRACT

A potable sanitary water dispenser station that dispenses water, yet prevents microorganisms from contaminating the water, having a frame adapted to support at least two inverted five-gallon water bottles, feeder hoses positioned to transfer water from each inverted water bottle to a selector valve inlet, a selector valve to allow a user to select a water bottle, the selector valve having a valve outlet, a cooling plate having an inlet and an outlet, a valve outlet hose connected to with the valve outlet and the cooling plate inlet, a spigot having an inlet and an outlet, and a cooling plate outlet hose connected to the cooling plate outlet and the spigot inlet, whereby a user can draw potable, sanitary, cooled water by using the spigot.

### BACKGROUND

1. Field of the Invention

The invention is related to water dispensers having a plurality of water bottles and a system for cooling the water below ambient temperature.

2. Description of the Related Art

Many people are involved in outdoor sports, like golf. They participate in outdoor sports for their recreational and health benefits. Outdoor sports venues, like golf courses, frequently supply drinking water to their guests, since it is well known that sports enthusiasts get thirsty.

A common way golf courses supply drinking water is to provide water stations such as the “water depots” sold by Great Lakes Golf Course Products. Other water stations are disclosed in U.S. Pat. No. 5,014,985, that issued on May 14, 1991 to Capps, and U.S. Pat. No. 6,012,790, that issued on Jan. 11, 2000 to Thomas et al., and which are not admitted to being prior art by their mention in this Background section. The central component of all of these water stations is a plastic, thermally insulated container with a removable top and a spigot near the bottom. The most common of these is a ten-gallon IGLOO cooler.

Other components of the water stations include a frame that houses the cooler, a stack of cups, and a trash receptacle. The frame can even have a display surface for posting relevant information.

The problem with this arrangement is that it is inherently unsanitary. The coolers are often filled with a garden hose that has been lying in dirt. The water warms up over time, thereby creating a growth medium for harmful microorganisms. Ice is often added by hand, that exposes the water to another source of contamination. An example of this problem became manifest in 2002 when more than 80 golfers at a Phoenix, Ariz., golf course became stricken with intestinal flu-like symptoms. One person died of the illness. Health officials cited improper handling of water jugs as the cause of the outbreak. The parents of the deceased golfer filed a wrongful death lawsuit against the golf club.

What is needed, therefore, is a potable sanitary water dispenser station that dispenses water, yet prevents microorganisms from contaminating the water.

### SUMMARY

A potable sanitary water dispenser station that dispenses water, yet prevents microorganisms from contaminating the water, comprises a frame adapted to support a plurality of inverted five-gallon water bottles, a plurality of feeder hoses positioned to transfer water from each inverted water bottle to a selector valve inlet, a selector valve adapted to allow a user to select a water bottle, said selector valve having a valve outlet, a cooling plate having an inlet and an outlet, a valve outlet hose in communication with the valve outlet and the cooling plate inlet, a spigot having an inlet and an outlet, and a cooling plate outlet hose in communication with the cooling plate outlet and the spigot inlet, whereby a user can draw sanitary cooled water by using the spigot. These and other features, aspects, and advantages of the present invention will become better understood with regard to the following description, claims, and accompanying drawings

### DRAWINGS

FIG. 1 is a cross section view of a water dispenser station according to the present invention.

FIG. 2 is a perspective view of the outside of a water dispenser station according to the present invention.

### DESCRIPTION

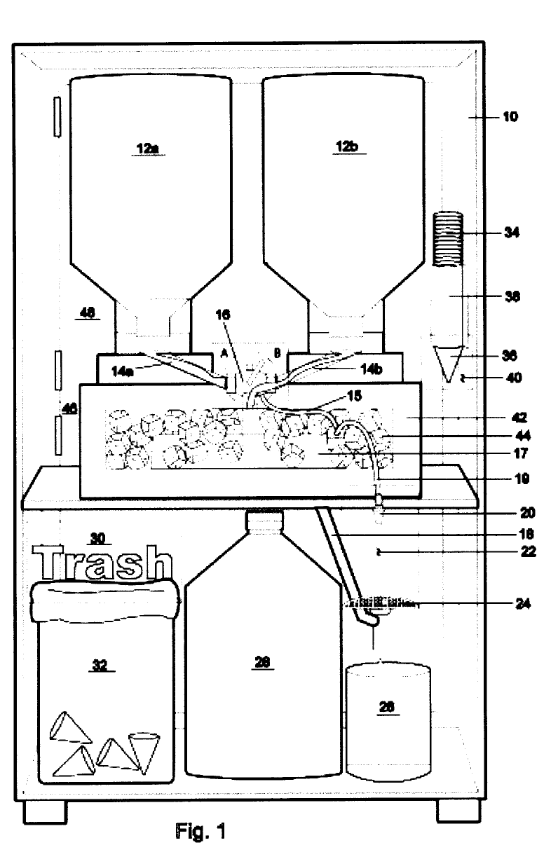

The invention is a potable sanitary water dispenser station that dispenses water, yet prevents microorganisms from contaminating the water. Turning to FIG. 1, a frame 10 is provided for positioning all the internal components in a secure manner. The frame is adapted to support a plurality of five-gallon water bottles 12a, 12b in an inverted position. The water bottles would be provided separately from the water dispenser station, and would preferably be filled with pure spring water and be sealed at the bottler. The preferred number of water bottles is two, but more can be provided.

Feeder hoses 14a, 14b are positioned under the five gallon water bottles 12a, 12b to transfer water to inlets of the selector valve 16. The selector valve 16 is selected so that a user can draw water from another water bottle when a first water bottle becomes empty. Alternatively, the station could be provided with an automatic apparatus to change the flow to a non-empty bottle when one bottle becomes empty. It is beneficial to drain one bottle completely before switching to the other to maintain freshness and avoid contamination.

Water then flows from the selector valve 16 through a valve outlet hose 15 to a cooling plate 17. The cooling plate 17 is preferably secured to the frame 10 in a cooling plate box 42 and is cooled by ice 44. Water flowing through the cooling plate 17 becomes cooler than ambient temperature.

From the cooling plate 17, the water flows through a cooling plate outlet hose 19 to a spigot 20. The user operates the spigot 20 to draw clean, cool, germ-free water. In the entire process, there has been no opportunity for contaminants to be introduced into the water.

Many other features can be provided with the present invention. For example, a spigot recess 22 shown by a dashed line can be provided to enable the user to place a cup 36 under the spigot more easily. Spills and drips can be caught on a grate 24 that empties into a spill bucket 26. Melting ice 44 in the cooling plate box 42 can also be directed to the spill bucket 26 by a cooling plate box hose 18.

A stack of cups 34 can be loaded in a cup holder 38 that is secured to the frame 10. The bottom cup 36 would preferably be visible in a cup recess 40 shown in FIG. 1 by a dashed line.

After the user has finished drinking the water, the user can discard the cup 36 in a trash receptacle 32 supplied inside the frame. A trash receptacle opening 30 is shown by a dashed line.

The preferred design of the water station according to the present invention permits the storage of a spare five-gallon water bottle 28 inside the frame 10. The water bottles in use 12a, 12b can be accessed by a water bottle access panel 48, shown as being hinged on one side. The cooling plate box 42 can be accessed for adding ice by a cooling plate box access panel 46, shown as being hinged on one side.

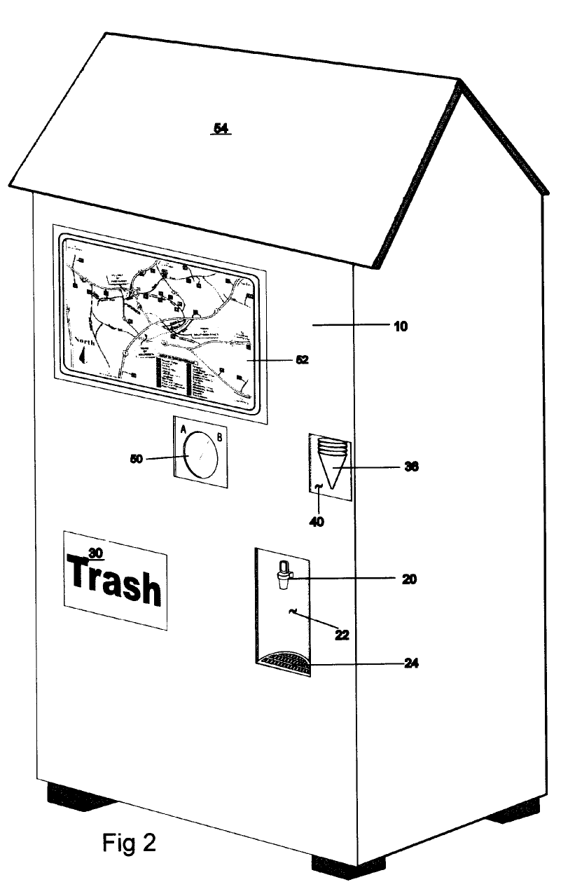

FIG. 2 is an outside perspective view of the present invention. The cup recess 40 and spigot recess 22 is clearly shown. The selector switch 16 has a manual control 50 that indicates which bottle is presently in use, and changes the bottle by moving the control.

A display surface 52 can be provided for showing useful information to the user. A map is shown in this example, but other information could be presented.

The frame 10 is topped by a functional, and preferably aesthetically pleasing, roof 54. The frame, and its coverings, can be made of metal, plastic, fiberglass, or other materials. A potable sanitary water dispensing station provided according to the present invention is a substantially maintenance free apparatus suitable for continuous outdoor use.

While there have been described what are at present considered to be the preferred embodiments of this invention, it will be obvious to those skilled in the art that various changes and modifications may be made therein without departing from the invention, and it is, therefore, aimed to cover all such changes and modifications as fall within the true spirit and scope of the invention.

What is claimed is:

1. A potable sanitary water dispensing station comprising:
a frame adapted to support a plurality of inverted five-gallon water bottles in a side-by-side arrangement;
a selector valve secured within the frame, said selector valve having at least one valve inlet and a valve outlet;
at least one feeder hose adapted to communicate with each inverted water bottle and a selector valve inlet;
a cooling plate having an inlet and an outlet;
a valve outlet hose in communication with the valve outlet and the cooling plate inlet;
a spigot having an inlet; and
a cooling plate outlet hose in communication with the cooling plate outlet and the spigot inlet,
whereby a user can draw potable sanitary cooled water by using the spigot.

2. The station of claim 1 further comprising a cup dispenser secured to the frame.

3. The station of claim 1 further comprising at least one panel secured to the outside of the frame, and a roof secured to the top of the frame.

4. The station of claim 3 further comprising a cup dispenser secured to the frame, and a cup recess in a panel through which cups in the cup dispenser are accessed by a user.

5. The station of claim 1 further comprising a switching means in communication with the selector valve for detecting when one water bottle is empty and switching to a non-empty bottle.

6. The station of claim 1, wherein the sector valve is a manually-operated selector valve.

7. The station of claim 1 further comprising a cooling plate box sized to receive the cooling plate and a load of ice for cooling the cooling plate.

8. The station of claim 7 further comprising a spill bucket below the spigot for receiving drips from the spigot and melted ice from the cooling plate box.

9. The station of claim 8 further comprising a cooling plate box hose in communication with the cooling box for directing melted ice to the spill bucket.

10. The station of claim 3 further comprising a spigot recess in a panel in which the spigot is secured, whereby a user can place a cup in the recess under the spigot to obtain sanitary cooled water.

11. The station of claim 10 further comprising a grate disposed at the bottom of the spigot recess.

12. The station of claim 3 further comprising a trash receptacle within the frame for receiving trash.

13. The station of claim 12 further comprising a trash receptacle opening in a panel near the trash receptacle.

14. The station of claim 3 further comprising a display surface on a panel for displaying information.

15. The station of claim 3, wherein the frame is made from one selected from the group consisting of metal, plastic, and fiberglass.

16. The station of claim 3, wherein the roof is made from one selected from the group consisting of metal, plastic, and fiberglass.

17. The station of claim 3, wherein the panel is made from one selected from the group consisting of metal, plastic, and fiberglass.

18. The station of claim 3, further comprising a water bottle access panel to facilitate changing water bottles.

19. The station of claim 7 further comprising a cooling plate box access panel to facilitate loading ice into the cooling plate box.

20. A potable sanitary water dispensing station comprising:
a frame adapted to support a plurality of inverted five-gallon water bottles in a side-by-side arrangement;
at least one panel secured to the outside of the frame;
a roof secured to the top of the frame;
a selector valve secured to the frame, said selector valve having a plurality of valve inlets and a valve outlet;
a plurality of feeder hoses adapted to communicate with each inverted water bottle and a selector valve inlet;
a cooling plate having an inlet and an outlet;
a valve outlet hose in communication with the valve outlet and the cooling plate inlet;
a spigot having an inlet; and
a cooling plate outlet hose in communication with the cooling plate outlet and the spigot inlet, whereby a user can draw sanitary cooled water by using the spigot.
